(19) United States
(12) Patent Application Publication
(10) Pub. No.: US 2009/0032154 A1
(43) Pub. Date: Feb. 5, 2009

(54) Adjustable Club Indentification Systems and Methods Manufacture Adjustable Club Indentification Systems

(76) Inventor: Frank A. Quartarone, III, Phoenix, AZ (US)

Correspondence Address: KARSTEN MANUFACTURING CORPORATION, LEGAL DEPARTMENT, 2201 WEST DESERT COVE, PHOENIX, AZ, 85029, US

(21) Appl. No.: 12/172,465

(22) Filed: Jul. 14, 2008

Related U.S. Application Data
(60) Provisional application No. 60/952,718, filed on Jul. 30, 2007.

(51) Int. Cl. A63B 57/00; G09F 3/18

(52) U.S. Cl. 150/160; 40/5; 40/649; 29/428

(57) ABSTRACT

Embodiments of adjustable club identification systems and methods to manufacture adjustable club identification systems are generally described herein. Other embodiments may be described and claimed.

### CROSS REFERENCE TO RELATED APPLICATIONS

This application claims the benefit of U.S. Provisional Application 60/952,718, filed Jul. 30, 2007.

### TECHNICAL FIELD

The present disclosure relates generally to golf equipment, and more particularly, to adjustable club identification systems and methods to manufacture adjustable club identification systems.

### BACKGROUND

In golf, head covers may be used to protect club heads of golf clubs from damage (e.g., dents, scratches, etc.) during storage and/or transit. In particular, a head cover may include an inner compartment to store and protect a club head of a golf club. The inner compartment may be made of fabric or other suitable materials that will not damage the outer surface of the club head.

Some head covers may include a club identifier to identify a golf club. For example, the club identifier may be based on a ball trajectory, a distance, a loft angle, or other parameters associated with the golf club. With a club identifier on the outer surface of a head cover, an individual may identify the golf club without removing the head cover.

### BRIEF DESCRIPTION OF THE DRAWINGS

FIG. 1 depicts a side view of an example golf bag having a plurality of golf clubs.

FIG. 2 depicts a back perspective view of an example head cover according to an embodiment of the methods, apparatus, and articles of manufacture described herein.

FIG. 3 depicts a top perspective view of an example housing portion of an example adjustable club identification system.

FIG. 4 depicts a top perspective view of an example removable insert portion associated with the housing portion of FIG. 3.

FIG. 5 depicts a top perspective view of an example adjustable club identification system of FIG. 3.

FIG. 6 depicts a top perspective view of an example golf club head.

FIG. 7 depicts a top perspective view of an example front portion of a housing portion.

FIG. 8 depicts a top perspective view of an example back portion associated with the front portion of FIG. 7.

FIG. 9 depicts a front perspective view of an example housing portion.

FIG. 10 depicts a front perspective view of an example removable insert portion.

FIG. 11 depicts a front perspective view of an example adjustable club identification system.

FIG. 12 depicts a back perspective view of an example golf club head cover.

FIG. 13 depicts a back perspective view of an example golf club head cover.

FIG. 14 depicts a back perspective view of an example golf club head cover.

FIG. 15 depicts one manner in which the adjustable club identifier systems described herein may be manufactured.

### DESCRIPTION

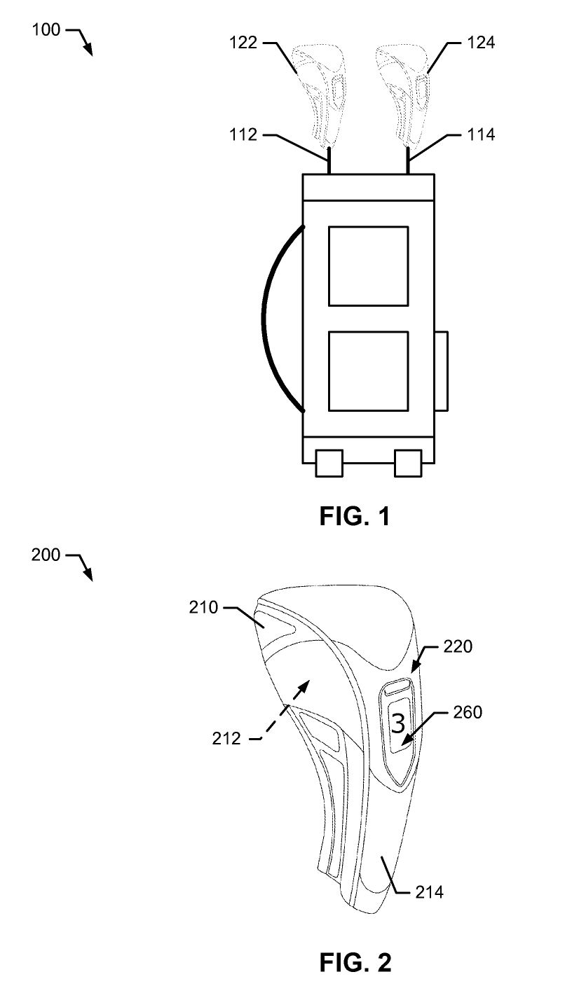

Referring to FIG. 1, for example, a golf bag 100 may include a plurality of golf clubs 110 (e.g., two golf clubs generally shown as 112 and 114). The golf bag 100 may be used to carry the plurality of golf clubs 110. An individual may include various combinations of golf clubs in the golf bag 100 based on various playing conditions of a round of golf or other various reasons. In one example, the golf bag 100 may include fourteen golf clubs with driver-type golf club(s), fairway wood-type golf club(s), hybrid-type golf club(s), iron-type golf club(s), wedge-type golf clubs, and/or putter-type golf club(s). Each of the plurality of golf clubs 110 may include a club head.

One or more club heads of the plurality of golf clubs 110 may be protected by the head covers 120 (e.g., two head covers generally shown as 122 and 124). In particular, the head covers 122 and 124 may protect the club heads of the golf clubs 112 and 114, respectively, from dents, scratches, paint chips, etc. during storage and/or transit of the plurality of golf clubs 110. As a result, the head covers 122 and 124 may mitigate damage to the club heads of the golf clubs 112 and 114, respectively. Without a club identifier, the head covers 120 may prevent an individual from readily identifying golf clubs because the club heads of those golf clubs may be covered by the head covers 120.

In the example of FIG. 2, a golf club head cover 200 may include a body portion 210 and an adjustable club identification system 220. The body portion 210 may include an inner compartment 212, and an outer surface 214. The body portion 210 may be made of a relatively flexible material (e.g., a fabric material, a plastic material, a rubber material, etc.) or a relatively rigid material (e.g., a metal material, a composite material, etc.). Alternatively, the body portion 210 may include a combination of relatively flexible material(s) and relatively rigid material(s). The inner compartment 212 may store or enclose at least a portion of a club head of a golf club. The outer surface 214 may include the adjustable club identification system 220.

As described in detail below, the adjustable club identification system 220 may simplify the manufacturing process of head covers by allowing a single head cover design to be manufactured for a type, a group, a set, or a subset of golf clubs. In one example, the adjustable club identification system 220 may permit manufacturing of identical head covers for a set of fairway wood-type golf clubs in a golf bag (e.g., a set containing a 3-wood golf club, a 5-wood golf club, and a 7-wood golf club). In another example, the adjustable club identification system 220 may permit manufacturing of identical head covers for golf clubs of various degrees of loft (e.g., 21°, 24°, etc.). The methods, apparatus, and articles of manufacture described herein are not limited in this regard.

As noted above, the club adjustable club identification system 220 may be located on or proximate to the outer surface 214 of the golf club head cover 200 to assist an individual to readily identify a golf club. In one example, the adjustable club identification system 220 may be located on or proximate to a back surface of the golf club head cover 200. In addition or alternatively, the adjustable club identification system 220 may be located on or proximate to a side surface or a front surface of the golf club head cover 200. The adjustable club identification system 220 may be temporarily affixed or attached to the outer surface 214 of the golf club head cover 200 by various methods including magnets, hook and loop, snaps, buttons, zippers, etc. Alternatively, the adjustable club identification system 220 may be permanently affixed or attached to the outer surface 214 of the golf club head cover 200 by various methods including adhesive, stitches, etc. The methods, systems, apparatus, and articles of manufacture described herein are not limited in this regard.

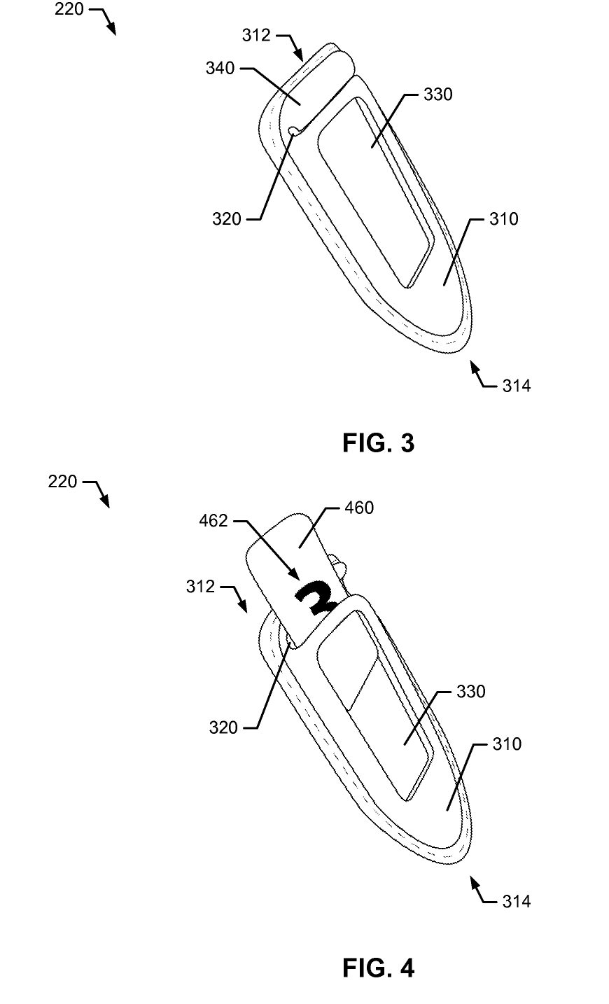

Turning to FIGS. 3, 4, and 5, for example, the adjustable club identification system 220 may include a housing portion 310, a receiving portion 320, and display portion 330. The housing portion 310 may be affixed to the outer surface 214 (FIG. 2) of the body portion 210 of the golf club head cover 200. As noted above, the housing portion 310 may be affixed to the outer surface 214 via adhesive, a series of stitches, etc. The housing portion 310 may include a first end 312 and a second end 314. The housing portion 310 may be made of a plastic material, a fabric material, a rubber material, a metal material, a composite material, any combination thereof, or any other suitable materials.

The receiving portion 320 may be located on the housing portion 310. In particular, the receiving portion 320 may be located at or proximate to the first end 312 of the housing portion 310. In addition or alternatively, the receiving portion 320 may be located at or proximate to the second end 314 of the housing portion 310 and/or any other sides of the housing portion 310 (e.g., left and/or right sides). For example, the receiving portion 320 may be a slit, an opening, a hole, etc.

The display portion 330 may be located between the first and second ends 312 and 314 of the housing portion 310. As described in detail below, the display portion 330 may be an opening, a hole, a transparent cover, one or more light emitting diodes, a liquid crystal display, or any combination thereof to display club identification information. While FIGS. 3, 4, and 5 may depict a rectangular shape, the display portion 330 may be a circular shape, a triangular shape, an elliptical shape, or any other suitable shapes to display club identification information.

The adjustable club identification system 220 may also include a removable insert portion 460 (FIG. 4). The removable insert portion 460 may be made of paper, plastic, metal, any combination thereof, or other suitable materials. The adjustable club identification system 220 may receive the removable insert portion 460 via the receiving portion 320 (FIG. 3). In particular, the removable insert portion 460 may include club identification information such as a club identifier 462 to identify a golf club. The club identifier 462 on a surface of the removable insert portion 460 may be painted, silk-screened, etched, cut, embroidered onto or into a surface of the removable insert portion 460, or any combination thereof. The club identifier 462 may be visible to an individual via the display portion 330. Accordingly, the club identifier 462 may indicate the club head within the inner compartment 212 (FIG. 2) of the head cover 200.

Also referring to FIG. 6, for example, a club head 600 may include club identification information, generally shown as 610. In one example, the club identification information may include a particular loft 612 of the club head 600 (e.g., loft of 16 degrees). In another example, the club identification information 610 may identify a particular type 614 of golf club (e.g., a 3-wood golf club). While FIG. 6 may depict a particular type of club head, the head covers described herein may be suitable for other suitable type of club heads (e.g., a driver-type club head, a hybrid-type club head, an iron-type club head, a wedge-type club head, a putter-type club head, etc.).

Accordingly, the club identifier 462 may include one or more characters, symbols, colors, etc. to identify the club head 600. For example, the club identifier 462 may be a numerical identifier, alphabetical identifier, or an alphanumerical identifier. In addition or alternatively, the club identifier 462 may include a color and/or other suitable types of identification. The methods, systems, apparatus, and articles of manufacture described herein are not limited in this regard.

Based on the adjustable club identification system 220, an individual may identify a golf club head of a golf club that may be within the inner compartment 212 of the golf club head cover 200. The adjustable club identification system 220 may permit the individual to use the golf club head cover 200 with another golf club by replacing the club identifier 462. In one example, the individual may use a club identifier with a “3” to indicate that the club head covered by the golf club head cover 200 is a 3-wood golf club. Subsequently, the individual may substitute the club identifier with a “5” to use the golf club head cover 200 for a 5-wood golf club. Alternatively, the individual may substitute the club identifier with a “7” to use the golf club head cover 200 for a 7-wood golf club. The methods, apparatus, and articles of manufacture described herein are not limited in this regard.

Turning back to FIGS. 3, 4, and 5, the housing portion 310 may include a flap portion 340. In particular, the flap portion 340 may secure the removable insert portion 460 within the housing portion 310. To remove the removable insert portion 460 from the housing portion 310, the flap portion 340 may be depressed so that the removable insert portion 460 may slide rearwardly from the housing portion 310 via the receiving portion 320. The methods, apparatus, and articles of manufacture described herein are not limited in this regard.

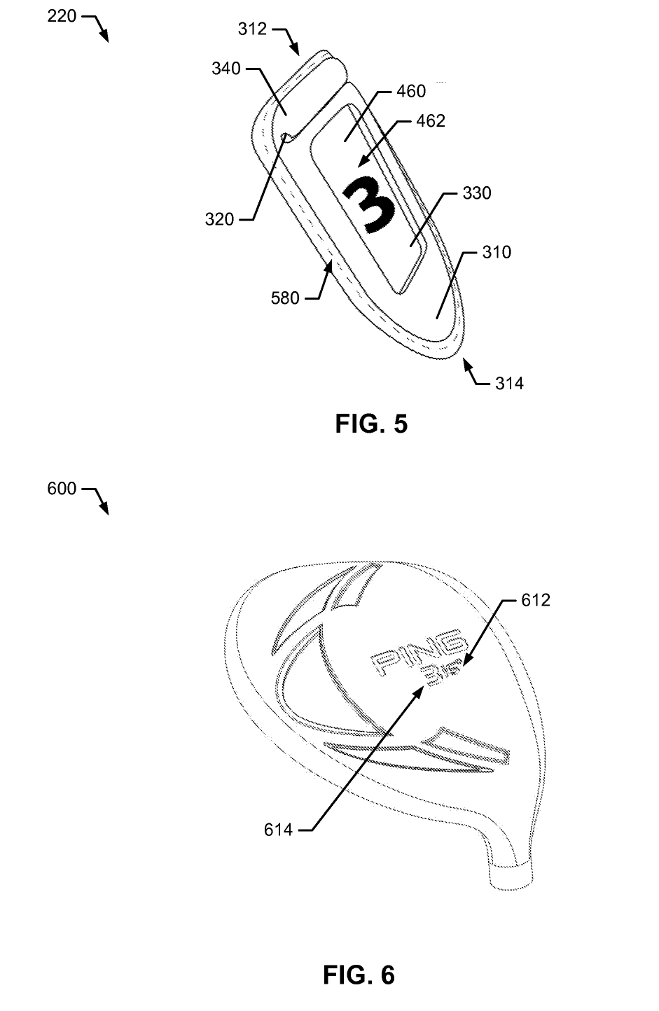

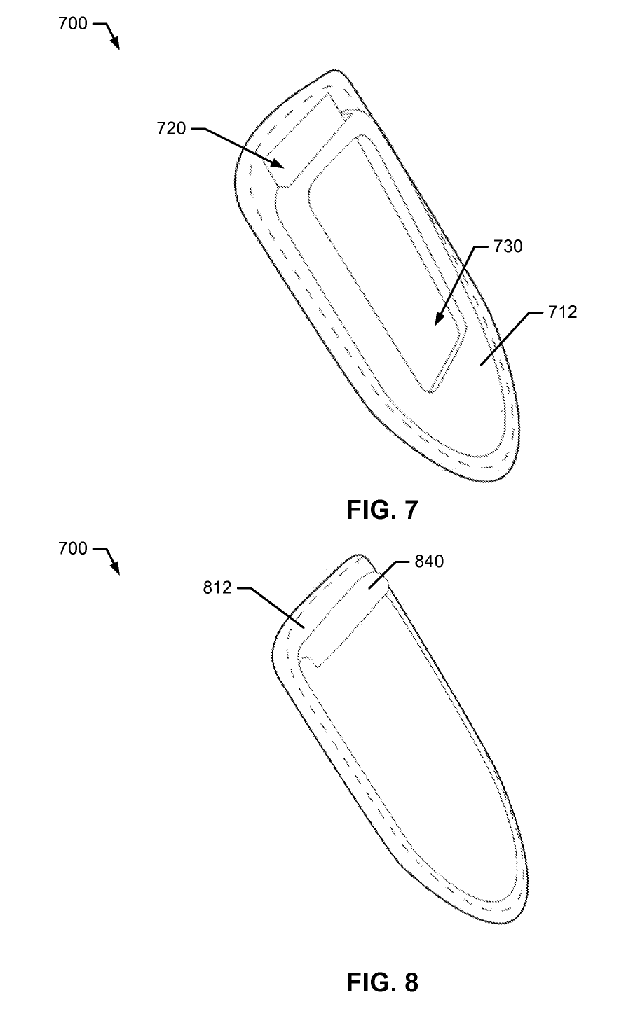

Although FIGS. 3, 4, and 5 may depict the housing portion 310 as a single unit, the adjustable club identification system 220 may be include two separate portions to form the housing portion 3 10. In the example of FIGS. 7 and 8, an adjustable club identification system 700 may include a housing portion comprising a front portion 712 (FIG. 7) and a back portion 812 (FIG. 8). The front portion 712 may include a display portion 730. The front and back portions 712 and 812 may be coupled to each other to form the housing portion of the adjustable club identification system 700. A removable insert portion (e.g., one shown as 460 in FIGS. 4 and 5) may be inserted into the housing portion of the adjustable club identification system 700 via the receiving portion 720. Accordingly, the club identifier (e.g., one shown as 462 in FIGS. 4 and 5) of the removable insert portion may be visible via the display portion 730.

The back portion 812 may include a flap portion 840 (FIG. 8). Similar to the flap portion 340 (FIGS. 3 and 5). In particular, the flap portion 840 may secure the removable insert portion within the housing portion. To remove the removable insert portion 460 from the housing portion, the flap portion 840 may be depressed so that the removable insert portion may slide rearwardly from the housing portion via the receiving portion 720. The methods, apparatus, and articles of manufacture described herein are not limited in this regard.

The adjustable club identification system 220 may be affixed to the golf club head cover 220 in various manners. In one example, the adjustable club identification system 220 may be temporarily affixed, permanently attached, or integrally molded to the golf club head cover 200. In contrast as described in the above examples, the adjustable club identification system 220 may be permanently attached to the outer surface 214 of the golf club head cover 200 via stitching, generally shown as 580. However, other methods may be used to attach the adjustable club identification system 220 to the golf club head cover 220 via adhesive such as glue, epoxy, etc. Alternatively, the adjustable club identification system 220 may be integrally molded into the golf club head cover 200. The methods, apparatus, and articles of manufacture described herein are not limited in this regard.

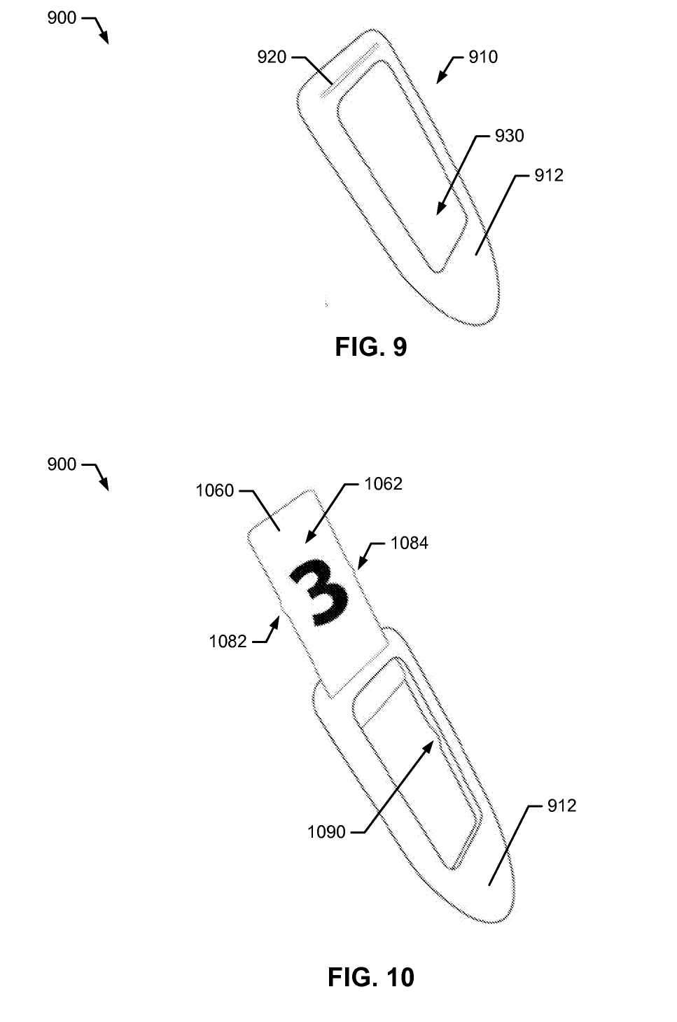

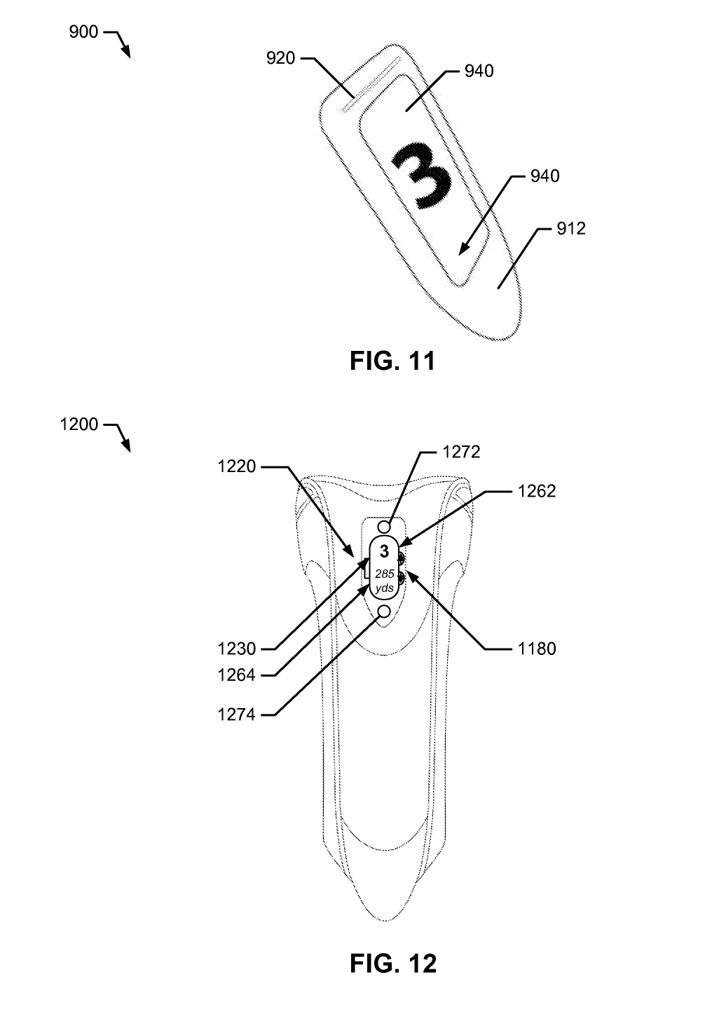

Referring to FIGS. 9, 10, and 11, for example, an adjustable club identification system 900 may include a housing portion 910. In contrast to the housing portion 710 of the adjustable club identification system 700 as depicted in FIGS. 7 and 8, the housing portion 910 may include a front portion 912 but no back portion. The front portion 912 may include a receiving portion 920 and a display portion 930 of the adjustable club identification system 900. The housing portion 910 of the adjustable club identification system 900 may be formed by affixing the front portion 912 directly to a golf club head cover. Accordingly, an outer surface (e.g., the outer surface 214 of FIG. 2) of a golf club head cover may provide back support for the housing portion 910.

A removable insert portion 1060 (FIG. 10) may be inserted into the housing portion of the adjustable club identification system 900 via the receiving portion 920. One side (e.g., a back side) of the removable insert portion 1060 may rest directly on the outer surface of the golf club head cover. On the opposite side, the club identifier 1062 (FIG. 10) of the removable insert portion 1060 may be visible via the display portion 930.

To prevent the removable insert portion 1060 from being displaced within the housing portion 910, the removable insert portion 1060 may have one or more protrusions, generally shown as 1082 and 1084, along the edges to fit into one or more recesses, generally shown as 1090 within the front portion 912. Other types of retention features may be used to restrict movement of the insert after assembly. For example, one or more high friction portions may be included to either the outer surface of the golf club head cover or a back side of the removable insert portion 1060. The methods, apparatus, and articles of manufacture described herein are not limited in this regard.

Referring to FIG. 12, for example, a golf club head cover 1200 may include an adjustable club identification system 1220 to display club identification information 1262. In particular, the adjustable club identification system 1220 may be affixed to an outer surface of the golf club head cover 1200 via one or more magnets, generally shown as 1272 and 1274. Accordingly, the entire adjustable club identification system 1220 may be removed from the golf club head cover 1200.

The adjustable club identification system 1220 may include a display portion 1230. The display portion 1230 may be an electronic display to indicate the club identification information 1262. In addition or alternatively, the display portion 1230 display club performance information 1264 on the golf club head cover 1200. The display portion 1230 may receive information through via a user input 1280 located on the adjustable club identification system 1220. In one example, the adjustable club identification system 1220 may store and display the average ball flight distance for a particular golf club via the display portion 1230. Visual presentation of performance-related information on the golf club head cover 1200 may assist an individual to select an appropriate golf club for a shot. The methods, apparatus, and articles of manufacture described herein are not limited in this regard.

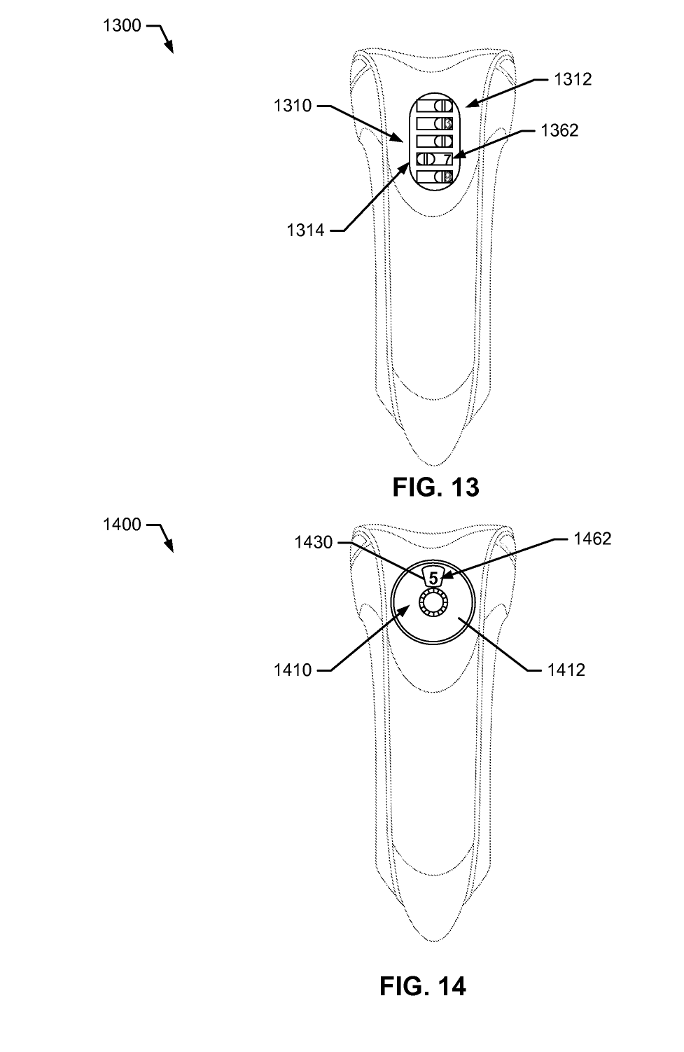

In the example of FIG. 13, a golf club head cover 1300 may include an adjustable club identification system 1310 to display club identification information 1362. In particular, the adjustable club identification system 1310 may include two or more sliding selectors 1310 (e.g., two selectors generally shown as 1312 and 13 14). The sliding selectors 1310 may be configured horizontally, vertically, or diagonally. The adjustable club identification system 1310 may also include a removable insert portion, which in turn, may include the club identification information 1362. For example, the appropriate club identification information 1362 may be revealed or hidden by adjusting the sliding selectors 13 10. The methods, systems, apparatus, and articles of manufacture described herein are not limited in this regard.

Turning to FIG. 14, for example, a golf club head cover 1400 may include as an adjustable club identification system 1410 to display club identification information 1462. In particular, the adjustable club identification system 1410 may include a rotary dial 1412. The adjustable club identification system 1410 may also include a removable insert portion (e.g., a disc), which in turn, may include the club identification information 1462. For example, the appropriate club identification information 1462 may be displayed via a display portion 1430 by turning the rotary dial 1412. The methods, systems, apparatus, and articles of manufacture described herein are not limited in this regard.

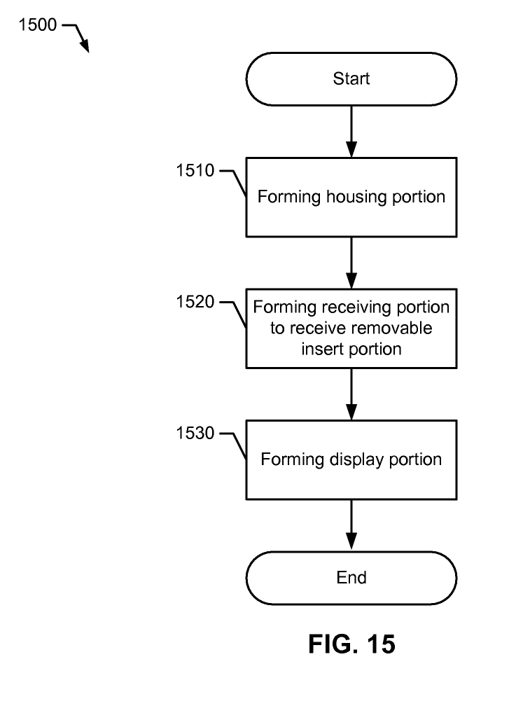

In the example of FIG. 15, a process 1500 may begin with forming a housing portion to affix to an outer surface of a golf club head cover (block 151 0). In particular, the housing portion may include a first end and a second end. The process 1500 may form a receiving portion located on the housing to receive a removable insert portion (block 1520). The removable insert portion may include a club identifier to identify a golf club. The process 1500 may form a display portion located between the first end and the second end to display at least a portion of the club identifier (block 1530). As a result, the process 1500 may provide an adjustable club identification system so that an individual may identify a golf club without removing the golf club head cover. Further, the individual may adjust and use the golf club head cover for another golf club by changing the removable insert portion, which in turn, changes the club identification information. The methods, apparatus, and articles of manufacture are not limited in this regard.

Although a particular order of actions is illustrated in FIG. 15, these actions may be performed in other temporal sequences. For example, two or more actions depicted in FIG. 15 may be performed sequentially, concurrently, or simultaneously. While FIG. 15 may depict a particular number of blocks, the process 1500 may not perform one or more blocks.

Although one or more figures may depict a head cover for metal wood-type club heads (e.g., driver-type club heads, fairway wood-type club heads, hybrid-type club heads, etc.), the methods, apparatus, and articles of manufacture described herein may be applicable to other suitable types of club heads. Further, while the above examples may be described with respect to a golf club head cover of a golf club, the methods, apparatus, systems, and articles of manufacture described herein may be applicable to other suitable types of sport equipments. For example, the identification system described herein may be applicable to covers for shoes, watches, etc.

Although certain example methods, apparatus, and/or articles of manufacture have been described herein, the scope of coverage of this disclosure is not limited thereto. On the contrary, this disclosure covers all methods, apparatus, and/or articles of manufacture fairly falling within the scope of the appended claims either literally or under the doctrine of equivalents.

What is claimed is:

1. An apparatus comprising:
a housing portion configured to affix to an outer surface of a golf club head cover, the housing portion having a first end and a second end;
a receiving portion located on the housing portion to receive a removable insert portion having club identification information to identify a golf club; and
a display portion located between the first end and the second end to display the club identification information.

2. An apparatus as defined in claim 1, wherein the housing portion comprises at least one of a housing portion temporary affixed to the outer surface or a housing portion permanently affixed to the outer surface.

3. An apparatus as defined in claim 1, wherein the housing portion comprises at least one of a plastic material, a fabric material, a rubber material, a metal material, or a composite material.

4. An apparatus as defined in claim 1, wherein the receiving portion comprises at least one of a slit, an opening, or a hole.

5. An apparatus as defined in claim 1, wherein the display portion comprises at least one of an opening, a transparent cover, one or more light emitting diodes, or a liquid crystal display.

6. An apparatus as defined in claim 1, wherein the removable insert portion comprises a paper insert, a plastic insert, or a memory card.

7. An apparatus as defined in claim 1, wherein the club identification information comprises at least one of a numerical identifier, an alphabetical identifier, an alphanumeric identifier, or a color identifier.

8. An apparatus as defined in claim 1, wherein the club identification information is associated with at least one of a club loft of the golf club or a club type of the golf club.

9. An apparatus as defined in claim 1, wherein the golf club comprises at least one of a driver-type golf club, a fairway wood-type golf club, a hybrid-type golf club, an iron-type golf club, a wedge-type golf club, or a putter-type golf club.

10. A golf club head cover comprising:
a body having an outer surface and an inner compartment to house at least a portion of a golf club head of a golf club;
a housing portion configured to affix to the outer surface, the housing having a first end and a second end;
a receiving portion located on the housing portion to receive a removable insert portion having club identification information to identify a golf club; and
a display portion located between the first end and the second end to display the club identification information.

11. A golf club head cover as defined in claim 10, wherein the housing portion comprises at least one of a plastic material, a fabric material, a rubber material, a metal material, or a composite material.

12. A golf club head cover as defined in claim 10, wherein the receiving portion comprises at least one of a slit, an opening, or a hole.

13. A golf club head cover as defined in claim 10, wherein the display portion comprises at least one of an opening, a transparent cover, one or more light emitting diodes, or a liquid crystal display.

14. A golf club head cover as defined in claim 10, wherein the removable insert portion comprises a paper insert, a plastic insert, or a memory card.

15. A golf club head cover as defined in claim 10, wherein the club identification information comprises at least one of a numerical identifier, an alphabetical identifier, an alphanumeric identifier, or a color identifier.

16. A golf club head cover as defined in claim 10, wherein the golf club comprises at least one of a driver-type golf club, a fairway wood-type golf club, a hybrid-type golf club, an iron-type golf club, a wedge-type golf club, or a putter-type golf club.

17. A golf club system comprising:
a golf club having a club head;
a head cover configured to enclose at least a portion of the club head; and
an club identification system configured to affix to the head cover, the adjustable club identification system having a housing portion to a receiving portion to receive a removable insert portion and a display portion to display at least a portion of the removable insert portion,
wherein the removable insert portion comprises club identification information to identify the golf club.

18. A golf club system as defined in claim 17, wherein the club identification information comprises at least one of a numerical identifier, an alphabetical identifier, an alphanumeric identifier, or a color identifier.

19. A golf club system as defined in claim 17, wherein the adjustable club identification system comprises at least one of a rotary dial, a sliding selector, or an electronic display.

20. A golf club system as defined in claim 17, wherein the adjustable club identification system comprises a system affixed to the head cover via one or more magnets, one or more hooks and loops, one or more snaps, one or more buttons, or one or more zippers.

21. A method comprising:
forming a housing portion to affix to an outer surface of a golf club head cover, the housing portion having a first end and a second end;
forming a receiving portion located on the housing portion to receive a removable insert portion having club identification information to identify a golf club; and
forming a display portion located between the first end and the second end to display at least a portion of the club identification information.

22. A method as defined in claim 21 further comprising forming the receiving portion comprises forming a slit, an opening, or a hole.

23. A method as defined in claim 21 further comprising affixing the housing portion to the outer surface via at least one of one or more magnets, one or more hooks and loops, one or more snaps, one or more buttons, or one or more zippers.

24. A method as defined in claim 21 further comprising providing at least one of a numerical identifier, an alphabetical identifier, an alphanumeric identifier, or a color identifier as the club identification information.
